(19) United States
(12) Patent Application Publication
(10) Pub. No.: US 2006/0087061 A1
(43) Pub. Date: Apr. 27, 2006

(54) Manufacturing method for heat retaining and flame retardant and heat insulating building material component

(76) Inventor: Kuo-Young Wei, Hsin Tien City (TW)

Correspondence Address: Kuo-Young Wei, P.O. Box No. 6-57, Junghe, Taipei, 235, TW

(21) Appl. No.: 11/014,984

(22) Filed: Dec. 20, 2004

(30) Foreign Application Priority Data
Oct. 21, 2004 (TW) 093131944

(51) Int. Cl. C04B 35/64

(52) U.S. Cl. 264/621

(57) ABSTRACT

A manufacturing method and device for heat retaining, flame retardant and heat insulating building material component embodying a receptacle, which is provided with a material feed hole; super absorbent polymer powder, which is supplied into the receptacle through the material feed hole; and liquid water, a large quantity of which is supplied into the receptacle through the material feed hole, whereupon contents of the receptacle is moderately stirred under room temperature, whereafter the super absorbent polymer powder absorbs the water and expands to form a saturated gel within an interior space of the receptacle. A cover is then used to tightly seal the material feed hole, and which thereby forms a building material component. The water saturated gel within the building material component provides the building material component with functionality to retain heat, retard flames, and effectiveness of heat insulation and sound insulation when used for construction purposes.

### BACKGROUND OF THE INVENTION

(a) Field of the Invention

The present invention relates to a manufacturing method and artifact for heat retaining, flame retardant and heat insulating building material component, and more particularly to the building material component interior of which is filled with a gel of high water of saturation, which therewith achieves effectiveness of heat retention, flame retardant, heat insulation and sound insulation.

(b) Description of the Prior Art

A super absorbent polymer applied for use as a water-retaining material was invented by an American scientist as early as 1965, and used as a water-retaining agent in soil. Continuous development in such art has brought about incessant innovative improvement in water-retaining agent raw materials in recent years, and new super absorbent polymers have already been developed. Such super absorbent polymer materials can absorb moisture a hundredfold their own weight. Furthermore, the absorbed moisture resists being released when subjected to squeezing, and thus has excellent water-retaining properties.

However, all such water-retaining agents are used in agricultural soils to effectuate water-retaining properties, and thus practical usage of such water-retaining agents is extremely limiting. Hence, research task of the present invention is in providing the super absorbent polymer that can be used in building materials.

### SUMMARY OF THE INVENTION

Accordingly, a primary objective of the present invention is to provide a manufacturing method and artifact for heat retaining, flame retardant and heat insulating building material component, which uses interior volume of the building material component filled with a water saturated gel to provide the building material component with functionality to retain heat, retard flames, and effectiveness of heat insulation and sound insulation when used for construction purposes.

Referring to FIGS. 1 to 5, the manufacturing method and artifact for heat retaining, flame retardant and heat insulating building material component of the present invention comprises:

A receptacle, provided with a material feed hole.

Super absorbent polymer powder is supplied into the receptacle through the material feed hole, whereafter a large quantity of liquid water is supplied into the receptacle through the material feed hole, whereupon contents of the receptacle is moderately stirred under room temperature, whereafter the super absorbent polymer powder absorbs the water and expands to form a saturated gel in an interior space of the receptacle. A cover is then utilized to tightly seal the material feed hole, which thereby forms a building material component.

Referring to FIG. 3, a preferred composition mixture ratio of the super absorbent polymer powder and the water is 1:300 by weight, whereby the super absorbent polymer powder completely absorbs the water, and assumes the expanded saturated gel state.

Referring to FIG. 5, which shows that volume of the saturated gel within the receptacle does not completely fill up the interior space of the receptacle, but reserves an air space T.

Wherein material of the super absorbent polymer powder is polyacrylamide. PAM having chemical formula: 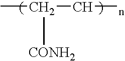
and n is a positive integer.

Wherein material of the super absorbent polymer powder 20 is acrylic resin and its derivatives 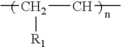
and R₁ can be CONH₂, CN, COOH⁺, COONa⁺, COONH₄⁺; and n is a positive integer.

Wherein material of the super absorbent polymer powder 20 is a starch-acrylonitrile graft copolymer having chemical formula: (C₆H₁₀O₅—CH₂CHCN)ₙ, or starch graft polyacrylic acid or its derivatives; or polyacrylate or a copolymer of derivatives of polyacrylate.

Referring to FIGS. 8 to 14, wherein the plurality of building material members can be mutually interlocked, thereby forming a vertical wall, a horizontal wall or an indoor ceiling.

Referring to FIGS. 1 and 5, the present invention provides an artifact for heat retaining, flame retardant and heat insulating building material component comprising:

The rectangular receptacle, the interior space of which is filled with and stores the completely saturated gel.

The cover, which tightly fits and is thereby fixedly configured in the material feed hole of the receptacle, and thus the receptacle forms the sealed building material component.

Referring to FIG. 6, which shows the building material component configured with protrusions and indents, allowing interlocking of adjacent building material components therewith, and which can realize assembly of a horizontal wall or a vertical wall of a building structure (see FIGS. 8 and 9).

Referring to FIG. 11, which shows a front surface and a back surface of each of the building material components configured with a protrusion and an indent respectively. The protrusion of one of two adjacent building material components imbeds into the respective indent of the other adjacent building material component.

The building material component can be of a block form, a board form, a strip form, and so on. The receptacle can be fabricated from high reinforced impact proof fiberglass material.

The receptacle of the building material component can be further manufactured from high reinforced plastic material.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view of a building material component according to the present invention.

FIG. 2 shows a schematic cross-sectional view of the building material component having super absorbent polymer powder inputted thereinto according to the present invention.

FIG. 3 shows a schematic cross-sectional view of the building material component having liquid water inputted thereinto according to the present invention.

FIG. 4 shows a schematic cross-sectional view of the water and the polymer powder within the building material component being stirred according to the present invention.

FIG. 5 shows a schematic cross-sectional view of the polymer powder expanded after absorbing the water within the building material component according to the present invention.

FIG. 6 shows an elevational view of another embodiment of the building material component according to the present invention.

FIG. 7 shows a cross-sectional view of the other embodiment of the building material component according to the present invention.

FIG. 8 shows a schematic elevational view of the building material components in use to construct a horizontal wall according to the present invention.

FIG. 9 shows a schematic elevational view of the building material components in use to construct a vertical wall according to the present invention.

FIG. 10 shows a cross-sectional view of the building material components in use to construct a horizontal wall and a vertical wall according to the present invention.

FIG. 11 shows a side view of mutual locking of two adjacent building material components according to the present invention.

FIG. 12 shows a schematic cross-sectional view of the building material components in use to construct a vertical wall according to the present invention.

FIG. 13 shows a schematic cross-sectional view of the building material component for use as a ceiling board according to the present invention.

FIG. 14 shows a cross-sectional view of the building material component in use as ceiling boards and assembled to a light steel frame according to the present invention.

### DETAILED DESCRIPTION OF THE PREFERRED EMBODIMENTS

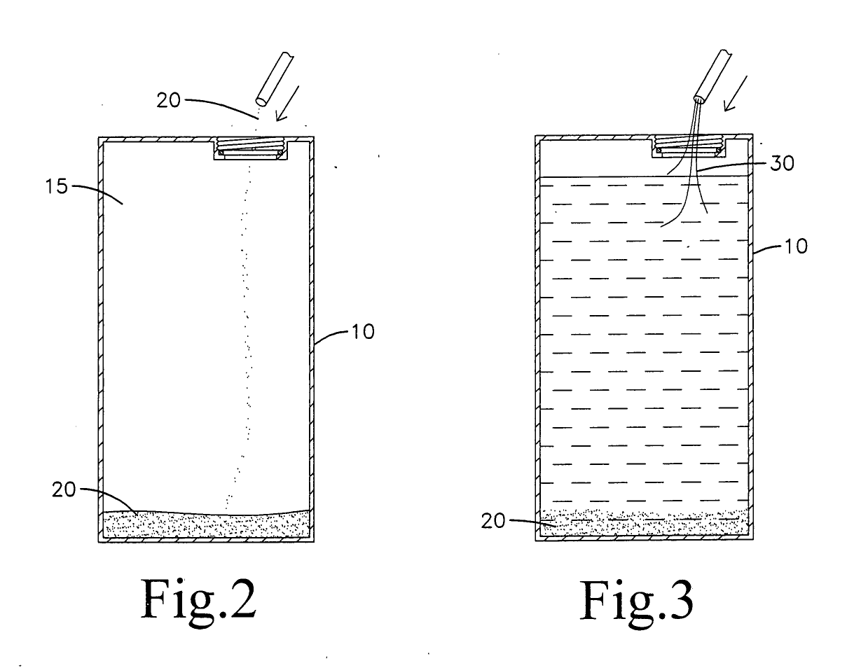

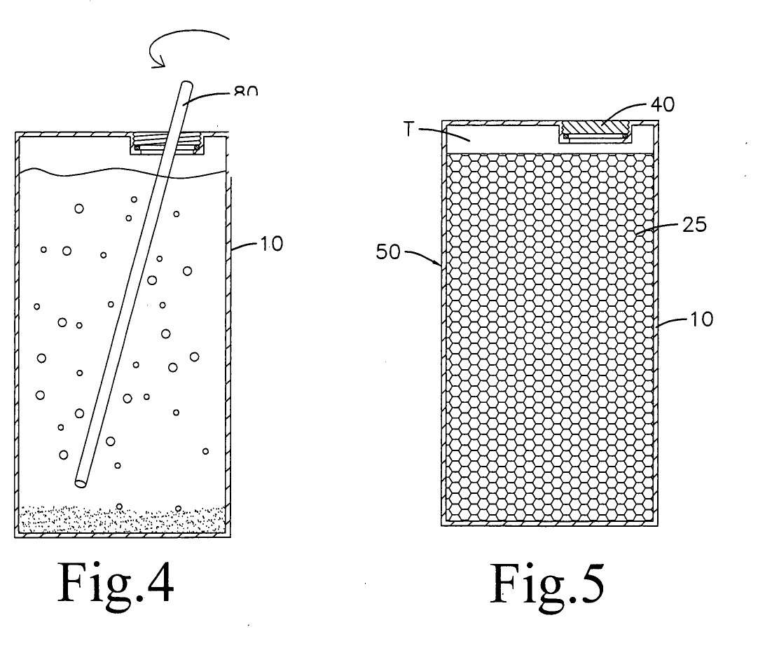

1. Referring to FIGS. 2, 3, 4, and 5, wherein composition mixture ratio of super absorbent polymer powder 20 and liquid water 30 within a receptacle 10 of the present invention is between 1:300˜500 by weight. The solid polymer powder 20 and the liquid water 30 are then subjected to uniform stirring by a tool 80 or the receptacle 10 is shaken under room temperature, which thus effectuates uniform mixing of the polymer powder 20 and the water 30, and whereby the super absorbent polymer powder 20 quickly absorbs a large quantity of the water 30 and expands. The water 30 absorbed by the polymer powder 20 can amount to between 300˜500 times original weight of the polymer powder 20, which thereby enables the polymer powder 20 to completely expand and form a gel 25 within an interior space 15 of the receptacle 10. Volume of the gel 25 formed after expansion within the interior space 15 of the receptacle 10 occupies between 90%˜95% of the interior space 15, and thus reserves an air space T occupying 10%˜5% of the receptacle 10. Function of the air space T is actualized when the building material component 50 is used in a building structure, whereby because of variation in external atmospheric temperature and physical properties of cold expansion and heat contraction of the water 30, the gel 25 will freeze and assume a solid state when the temperature drops below 0° C., whereupon the gel 25 will completely expand (because of large quantity of water molecules in the gel 25), and thus fill up the air space T.

However, when the temperature rises to a certain level, the solid gel 25 will absorb the external temperature and resume original semifluid gel form, and thus volume of the gel 25 also reverts back to original volume, and the air space T is again formed.

Furthermore, material of the super absorbent polymer powder 20 can be composed from a copolymer produced from at least one or more than one of the following materials: poly acrylamide (PAM), acrylic resin, starch-acrylonitrile graft copolymer, starch-methacrylamide graft copolymer, acrylamide and methacrylamide.

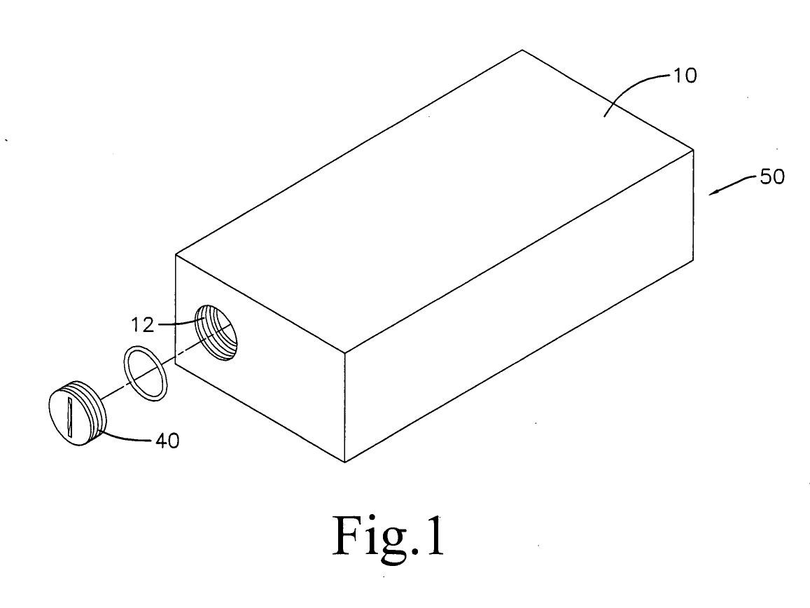

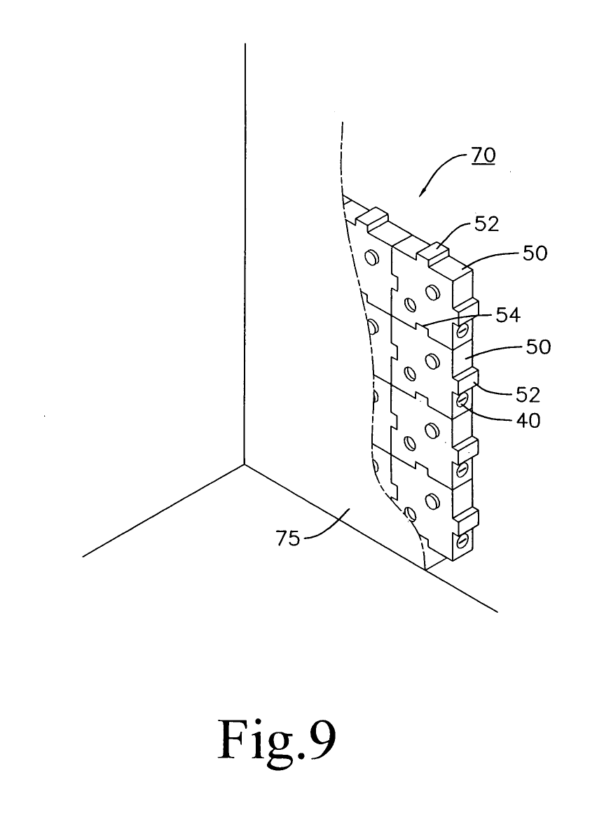

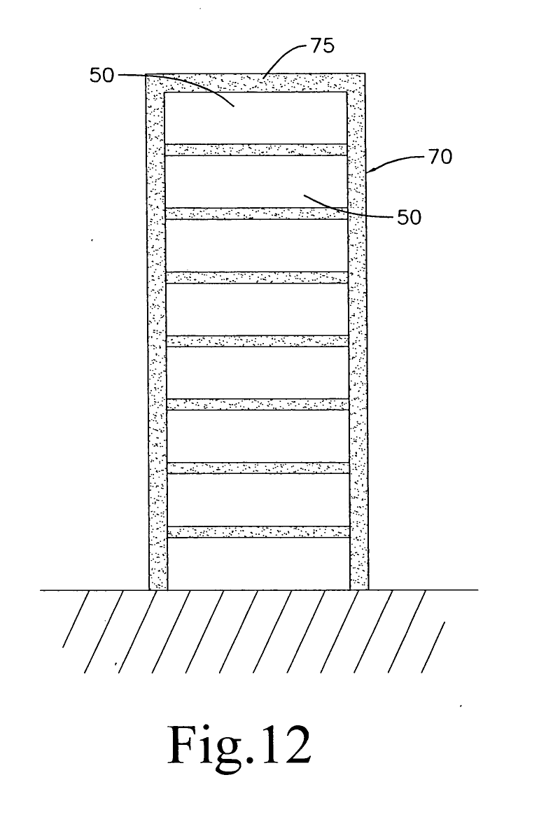

2. Referring FIG. 1, the receptacle 10 of the present invention 10 is preferably fabricated from fiberglass material or ultra hard and high reinforced plastic. Shape of the receptacle 10 can assume a brick form, which is applicable for use as a building material. The Building material component 50 can be piled up to form a vertical wall 70 (see FIG. 9). Referring to FIG. 12, an embellishing layer 75 of cement mortar plus fine sand is plastered over surface of the wall 70, thus forming the wall 70 of the building structure that has an entire form no different from that of a conventional wall. Furthermore, the embellishing layer 75 can be also fabricated from wooden boards, plastic boards or other covering material.

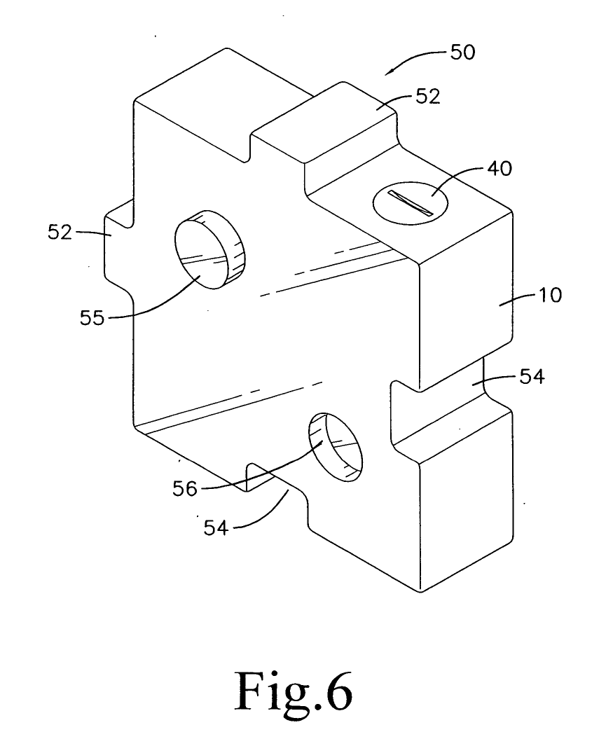

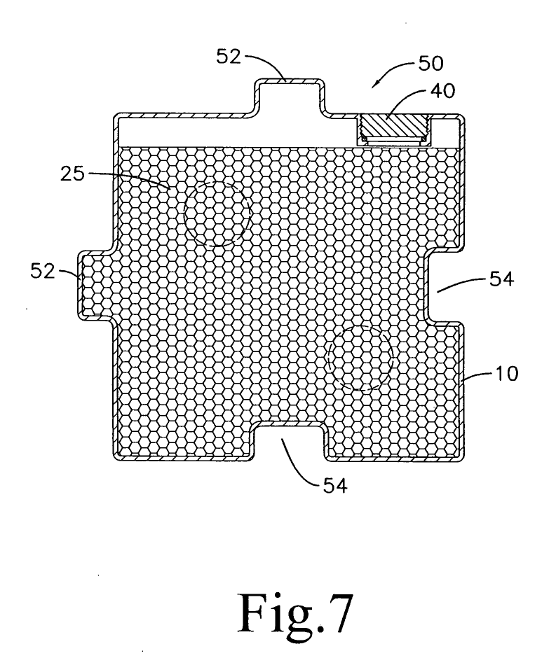

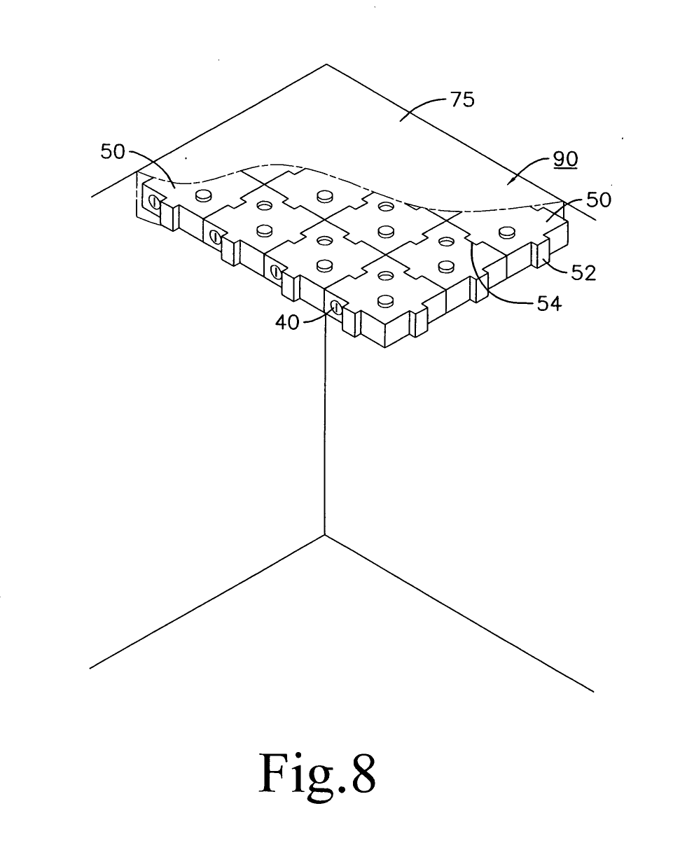

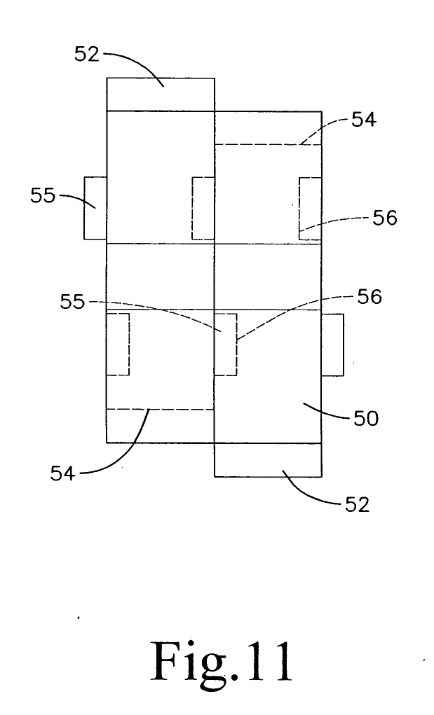

Referring to FIG. 6, in order to reinforce interlocking of the adjacent building material components 50 protrusions 52 and indents 54 are configured on side edges of the building material component 50, and a protrusion 55 and an indent 56 are configured on a top surface and a back surface of the building material component 50 respectively. With such a configuration, interlocking of the indents 54 and the protrusions 52 of mutually adjacent building material components 50 thereby realizes even firmer joining together of adjacent building material components 50. Referring to FIG. 8, which shows the present invention for use in constructing a horizontal wall, wherein all adjacent building material components 50 are interlocked, whereafter the embellishing layer 75 is plastered onto surfaces of the interlocking building material components 50, which thereby forms the horizontal wall 90. The other protrusions 55 of any two adjacent building material components 50 can imbed into the indents 56 of another adjacent building material component 50, and thereby achieve connecting of two building material components 50 in a parallel fashion to form an integral body (see FIG. 11).

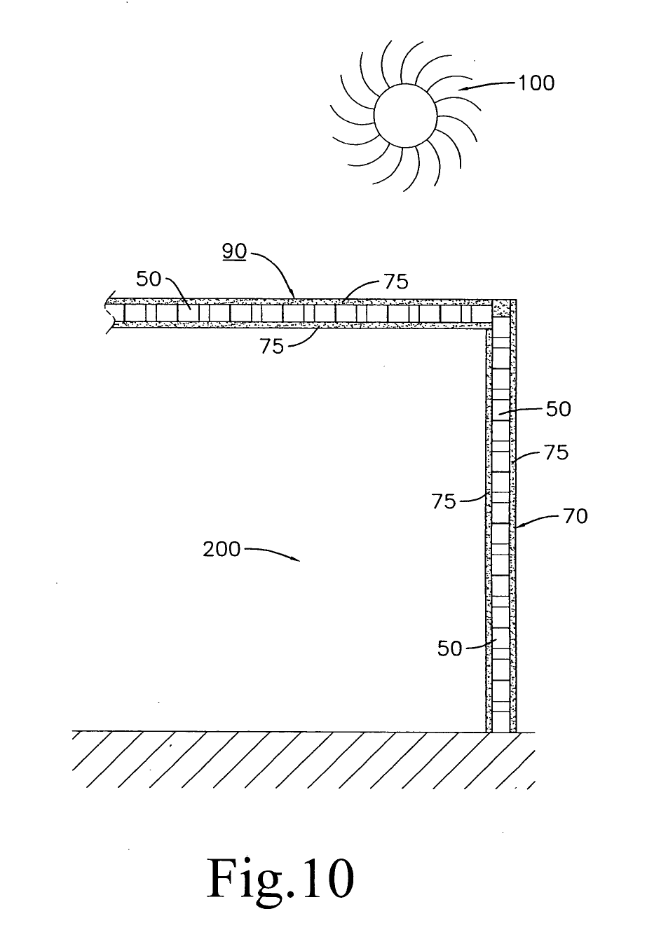

Referring to FIG. 10, when sunlight 100 shines onto the wall 70 and the horizontal wall 90, the saturated gel 25 containing a large quantity of water absorbs thermal energy (that is, stores heat energy) from the sunlight 100, at which time temperature of interior 200 will thus not significantly rise, and objective of heat insulation is thereby achieved. When the temperature drops in the evening, the heat energy stored within the gel 25 interior of the building material components 50 is slowly released to the interior 200, and thus the temperature of the interior 200 will not significantly drop, and thereby achieves objective of heat retainment. Hence, the building material components 50 of the present invention when applied for use in environments having an extreme temperature range (such as frigid zone areas) can positively achieve effectiveness of heat retainment or regulate temperature difference of the interior 200.

Furthermore, because the gel 25 in the building material component 50 of the present invention contains the large amount of water 30, thereby effectiveness of flame retardant can be achieved should a fire break out, and can thus be used as a fireproof material.

More particularly, the water 30 can significantly block transmission of sound waves, and, thus, the building material component 50 can be further used as a soundproofing material.

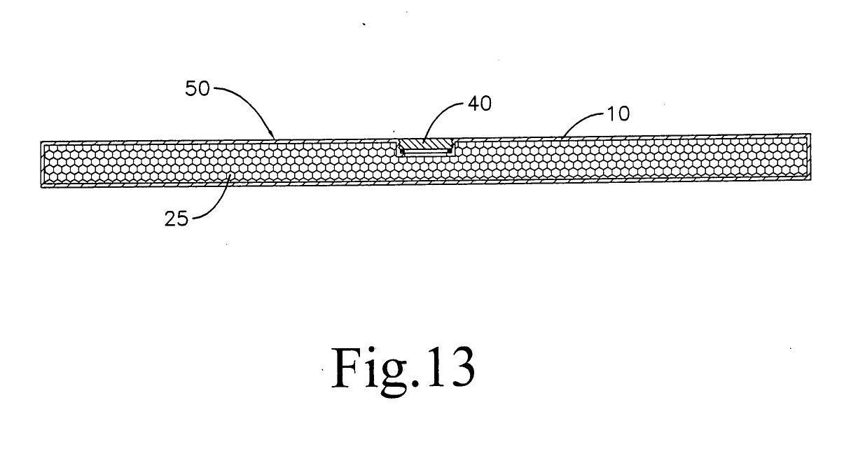

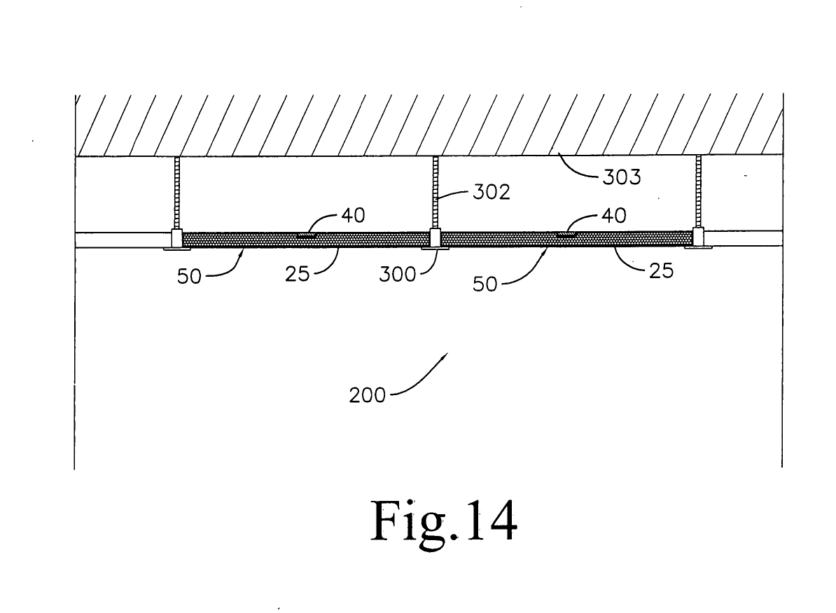

Referring to FIG. 13, wherein the building material component 50 is of a square board form or rectangular form, and which can be used as an indoor ceiling board material. Referring to FIG. 14, wherein a light steel frame 300 is a conventional L-shaped steel frame. The frame 300 is suspended from a top wall surface 303 by means of screws 302. The square building material components 50 can substitute for conventional plasterboards or sawdust boards, and thereby realize superior soundproof, heat insulation, flame retardant and heat retaining effectiveness.

When temperature heat energy of the interior 200 from cold air or hot air is conducted to the building material components 50, the saturated gel 25 interior of the receptacle 10 will absorb the temperature heat energy, and which thereby achieves effectiveness of retaining heat and preventing excessive escape of the heat energy from the interior 200. Furthermore, because the gel 25 of the building material component 50 contains the large quantity of water 30, thus effectiveness of flame retardant and sound insulation is achieved.

In conclusion, effectiveness of characteristics of the present invention has been eminently achieved. Accordingly, the inventor of the present invention hereby proposes a new patent application.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A manufacturing method for heat retaining, flame retardant and heat insulating building material component comprising;
a receptacle, which is provided with a material feed hole;
super absorbent polymer powder, which is supplied into the receptacle through the material feed hole;
liquid water, a large quantity of which is supplied into the receptacle through the material feed hole, whereupon contents of the receptacle is moderately stirred under room temperature, whereafter the super absorbent polymer powder absorbs the water and expands to form a saturated gel within an interior space of the receptacle; a cover is then used to tightly seal the material feed hole, and which thereby forms a building material component.

2. The manufacturing method for heat retaining, flame retardant and heat insulating building material component according to claim 1, wherein a preferred composition mixture ratio of the super absorbent polymer powder and the water is 1:300 by weight, whereby the super absorbent polymer powder completely absorbs the water, and assumes the expanded saturated gel state.

3. The manufacturing method for heat retaining, flame retardant and heat insulating building material component according to claim 1, wherein volume of the saturated gel within the receptacle does not completely fill up the interior space of the receptacle, but reserves an air space.

4. The manufacturing method for heat retaining, flame retardant and heat insulating building material component according to claim 1, wherein material of the super absorbent polymer powder is polyacrylamide (PAM) having chemical formula: 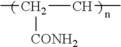
and n is a positive integer.

5. The manufacturing method for heat retaining, flame retardant and heat insulating building material component according to claim 1, wherein material of the super absorbent polymer powder is acrylic resin and its derivatives, having chemical formula: 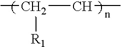
and R₁ can be CONH₂, CN, COOH⁺, COONa⁺, COONH₄⁺; and n is a positive integer.

6. The manufacturing method for heat retaining, flame retardant and heat insulating building material component according to claim 1, wherein material of the super absorbent polymer powder is a starch-acrylonitrile graft copolymer having chemical formula:
(C₆H₁₀O₅—CH₂CHCN)ₙ.

7. The manufacturing method for heat retaining, flame retardant and eat insulating building material component according to claim 1, wherein the plurality of building material components can be mutually interlocked, thereby forming a vertical wall, a horizontal wall or an indoor ceiling.

8. An artifact for heat retaining, flame retardant and heat insulating building material component comprising:
a rectangular receptacle, the interior space of which is filled with and stores the completely saturated gel;
the cover, which tightly fits and is thereby fixedly configured in the material feed hole of the receptacle, and thus the receptacle forms the sealed building material component.

9. The artifact for heat retaining, flame retardant and heat insulating building material component according to claim 8, wherein protrusions and indents are configured on side edges of the building material component, and interlocking of adjacent building material components is realized by means of the protrusions and indents, which thereby allows assembly of a horizontal wall or a vertical wall.

10. The artifact for heat retaining, flame retardant and heat insulating building material component according to claim 8, wherein a protrusion and an indent are configured on a front surface and a back surface of the building material component respectively, and whereby the protrusion of one of two adjacent building material component imbeds into the respective indent of the other adjacent building material component.

11. The artifact for heat retaining, flame retardant and heat insulating building material component according to claim 8, wherein the building material component can be of a block form, a board form, a strip form, and so on; and the receptacle can be fabricated from high reinforced impact proof fiberglass material.

12. The artifact for heat retaining, flame retardant and heat insulating building material component according to claim 8, wherein the receptacle of the building material component can be manufactured from high reinforced plastic material.
